(19) United States
(12) Patent Application Publication
(10) Pub. No.: US 2008/0198392 A1
(43) Pub. Date: Aug. 21, 2008

(54) Image Forming Apparatus and Calibration Method

(75) Inventor: Tomotaka Moriyama, Atsugi-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 11/765,630

(22) Filed: Jun. 20, 2007

(30) Foreign Application Priority Data
Feb. 19, 2007 (JP) 2007-037705

(51) Int. Cl. G06F 15/00

(52) U.S. Cl. 358/1.9

(57) ABSTRACT

Disclosed an image forming apparatus that adjusts density gradation characteristics based on density data obtained by forming a calibration image and measuring the formed calibration image and performing calibration, the image forming apparatus including: a storage section to store data related to adjustments of density gradation characteristics in past calibrations; and a control section to set density gradation characteristics which reproduces one of the past calibrations selected by a user based on the data selected by the user from among the data stored in the storage section and related to the adjustments of the density gradation characteristics in the past calibrations, and based on density data obtained by newly forming and measuring the calibration image.

### CROSS-REFERENCE TO RELATED APPLICATION

The present U.S. patent application claims a priority under the Paris Convention of Japanese patent application No. 2007-037705 filed on Feb. 19, 2007, which shall be a basis of correction of an incorrect translation.

### BACKGROUND

1. Field of the Invention

The present invention relates to an image forming apparatus and a calibration method, which adjust density gradation characteristics.

2. Description of Related Art

Heretofore, in an image forming apparatus such as a copier and a printer, since an output density varies according to a state and environment of the apparatus, the density has been adjusted by calibration.

For example, a scanner/printer has been proposed, which prints a predetermined fixed density pattern, reads the printed image by an image scanner, and corrects the scanner/printer so that a density of the printed image matches with a target density (see Japanese Patent Application Laid-open Publication No. 07-333930). Moreover, a printing apparatus has been proposed, which stores density calibration data corresponding to a plurality of environmental conditions in advance, measures a temperature and a humidity in the apparatus, and selects density calibration data corresponding to the measured temperature and humidity, thereby calibrating the density (see Japanese Patent Application Laid-open Publication No. 2001-341394). Furthermore, there is also a case of selecting a density desired by a user from among plural types of output densities, such as “lighter”, “standard”, and “darker”, prepared in advance.

However, heretofore, it has been merely possible to correct density gradation characteristics to those prepared in advance, such as a fixed target density. Consequently, it has been difficult, for example, to reproduce density gradation characteristics of a printing result in the past in such a case where a poster is desired to be printed in a similar tone to that of a poster printed on a certain day of a certain month in the past since the printing result of the poster printed on that date was good. In particular, in a printing industry that offers print on demand (POD), it has been frequent that, when a user requires to print the same printed matter as in the past one more time, he requires finished quality similar to that in the past.

### SUMMARY

The present invention has been made in consideration for the foregoing problem inherent in the related art. It is an object of the present invention to obtain a printing result similar to the printing result in the past.

In order to accomplish the above object, in accordance with a first aspect of the invention, an image forming apparatus that adjusts density gradation characteristics based on density data obtained by forming a calibration image and measuring the formed calibration image to perform calibration, the image forming apparatus includes: a storage section to store data related to adjustments of the density gradation characteristics in past calibrations; and a control section to set the density gradation characteristics which reproduces one of the past calibrations selected by a user, based on the data selected by the user from among the data stored in the storage section related to the adjustments of the density gradation characteristics in the past calibrations, and based on density data obtained by newly forming and measuring the calibration image.

Preferably, the storage section stores the data related to at least one adjustment of the density gradation characteristics in the past calibration with respect to each of printing purposes.

Preferably, the image forming apparatus further includes: an operation section to receive the selection by the user, wherein the control section receives the selection by the user from the operation section.

Preferably, the image forming apparatus further includes: a communication section to communicate with an external device, wherein the control section receives the selection by the user from the external device through the communication section.

### BRIEF DESCRIPTION OF THE DRAWINGS

These and other objects, advantages and features of the present invention will become more fully understood from the detailed description given hereinbelow and the appended drawings, and thus are not intended as a definition of the limits of the present invention, and wherein:

FIG. 1 is a block diagram showing a functional configuration of an image forming apparatus in an embodiment of the present invention;

FIG. 2 is a view showing an example of a calibration sheet;

FIG. 3A is a graph showing an example of density data;

FIG. 3B is a graph in which an axis of ordinates of FIG. 3A is revised;

FIG. 3C is a graph showing calibration data obtained from the density data;

FIG. 3D is a graph showing density gradation characteristics when gradation conversion processing is implemented for image data by using the calibration data;

FIG. 4A is a graph showing an example of density data in the past;

FIG. 4B is a graph showing calibration data obtained by correcting the calibration data;

FIG. 4C is a graph showing density gradation characteristics when the gradation conversion processing is implemented for the image data by using the calibration data;

FIG. 5A is a graph showing density gradation characteristics aimed when a maximum density capable of being currently outputted is lower than a maximum density in density data in the past;

FIG. 5B is a graph showing density gradation characteristics aimed when the maximum density capable of being currently outputted is lower than the maximum density in the density data in the past;

FIG. 6 is a flowchart showing calibration processing executed in the image forming apparatus;

FIG. 7 is a view showing a function selection screen;

FIG. 8 is a view showing a screen to select whether or not to use already registered density data;

FIG. 9 is a view showing a printing purpose selection screen;

FIG. 10 is a view showing density data selection screen;

FIG. 11 is a view showing a printing purpose selection screen;

FIG. 12 is a view showing a printing purpose name registration screen;

FIG. 13 is a view showing a density data storage screen.

### DETAILED DESCRIPTION OF THE PREFERRED EMBODIMENT

An image forming apparatus 10 in an embodiment of the present invention will be described.

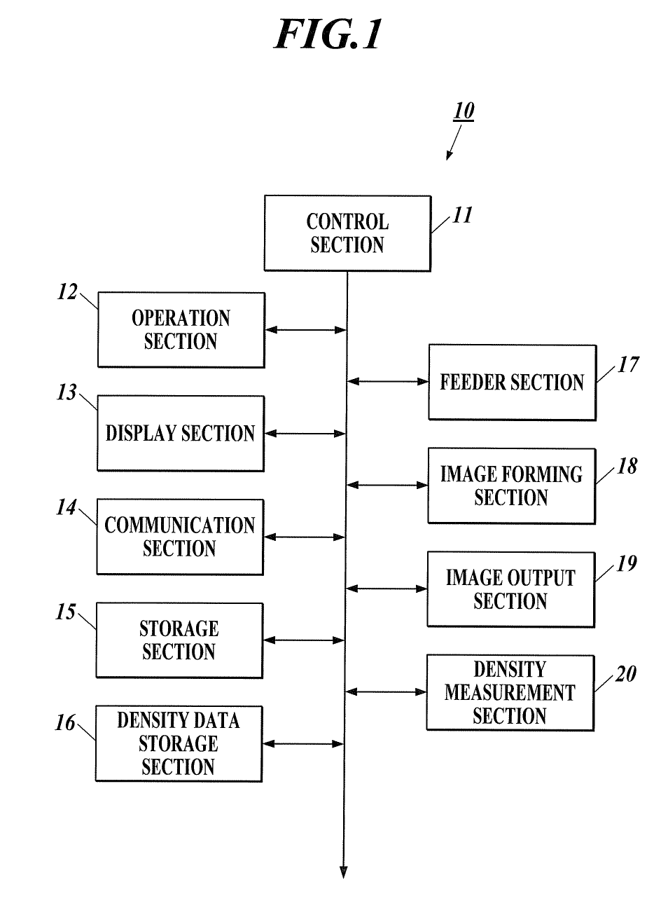

FIG. 1 shows a functional configuration of the image forming apparatus 10. As shown in FIG. 1, the image forming apparatus 10 includes a control section 11, an operation section 12, a display section 13, a communication section 14, a storage section 15, a density data storage section 16, a feeder section 17, an image forming section 18, an image output section 19, and a density measurement section 20. The image forming apparatus 10 is an image forming apparatus such as a copier, a printer, and a multi function peripheral (MFP).

The control section 11 includes a central processing unit (CPU), a read only memory (ROM), a random access memory (RAM), and the like, and controls processing operations of the respective sections of the image forming apparatus 10 in a centralized manner. In response to operation signals inputted from the operation section 12 or instruction signals received by the communication section 14, the CPU reads out a variety of processing programs stored in the ROM, expands the processing programs to the RAM, and executes a variety of processing in cooperation with the programs concerned.

The operation section 12 includes hard keys such as numeric keys, a start key, and a reset key, and when each of the keys is depressed, outputs a depression signal to the control section 11. Moreover, the operation section 12 includes a touch panel formed integrally on a surface of the display section 13, detects a position thereof touched by the fingertip of a user, a touch pen, or the like, and outputs a position signal to the control section 11. The operation section 12 receives a selection of any one piece of data representing a density (hereinafter, referred to as density data) in the past from among such density data stored in the density data storage section 16.

The display section 13 includes a liquid crystal display (LCD), and displays a variety of operation screens and a variety of processing results in accordance with instructions from the control section 11.

The communication section 14 is connected to a network of Ethernet® or the like, and transmits and receives data to and from an external instrument. For example, from a personal computer (PC), the communication section 14 receives image data instructed to be printed.

The storage section 15 is a non-volatile storage device such as a non-volatile memory, and stores a variety of data such as image data of calibration images, calibration data generated in calibration processing, and the printing target image data received from the outside by the communication section 14. Moreover, the storage section 15 temporarily stores the density data obtained by measuring the calibration images by the density measurement section 20.

The density data storage section 16 is a non-volatile storage device such as a hard disk, and as data related to adjustment of density gradation characteristics in the past calibrations, stores density date desired by the user from among the density data obtained by measuring the calibration images by the density measurement section 20. The density data is classified and stored into folders for each of printing purposes such as “poster”, “office document”, and “picture postcard”.

The feeder section 17 includes a feeder tray that houses printing sheets, and from among the printing sheets housed in the feeder tray, conveys printing sheets designated by the user to the image forming section 18 in accordance with an instruction from the control section 11.

The image forming section 18 forms the image on the printing sheets based on the image data by a printing method such as the electrophotographic method and the inkjet method. For example, at the time of the calibration processing, the image forming section 18 forms the calibration images on a printing sheet, and outputs a calibration sheet 30.

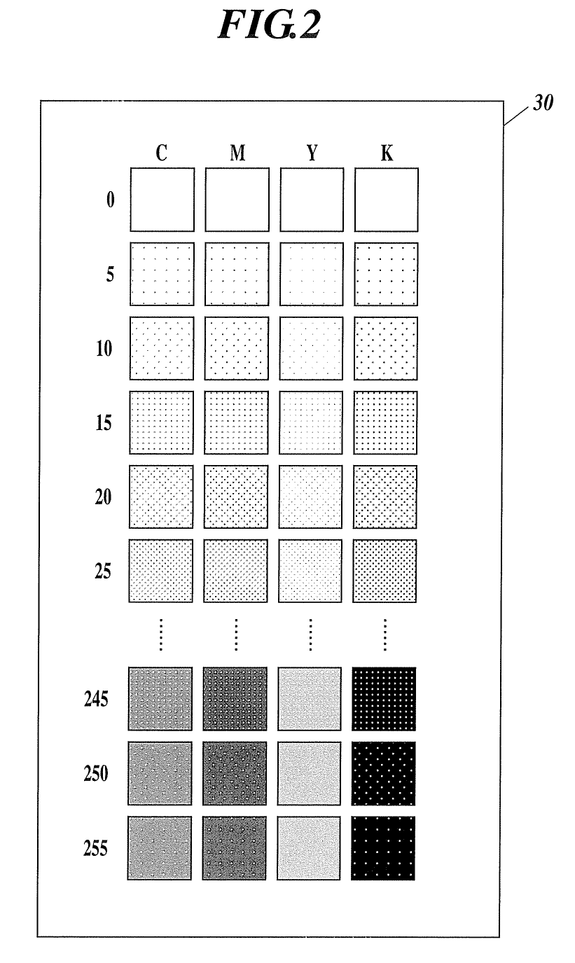

FIG. 2 shows an example of the calibration sheet 30. On the calibration sheet 30, images in which input values of the image data are taken every five gradations from 0 to 255, that is, 52 patches having gradual densities for each color of cyan (C), magenta (M), yellow (Y), and black (K) are formed as the calibration images.

The image output section 19 shown in FIG. 1 includes a paper receiving tray, and outputs the printing sheets, which are conveyed from the image forming section 18, onto the paper receiving tray in accordance with an instruction from the control section 11.

The density measurement section 20 includes a spectrophotometer of an incorporated type, measures densities of the patches of the respective colors of CMYK, which are the calibration images formed on the calibration sheet 30 conveyed from the image forming section 18, and generates the density data of the respective colors of CMYK. Note that, though the densities of the respective colors of CMYK are measured here, convertible values into the densities of the images, which include brightnesses and reflectances, may be measured. Moreover, the colors measured by the spectrophotometer may be represented by RGB, L*a*b*, XYZ, and the like.

Based on the image data obtained by measuring, by the density measurement section 20, the calibration images newly formed by the image forming section 18, the control section 11 generates data for matching output densities from the image forming section 18 with the input values of the image data of the calibration images, which are stored in the storage section 15, that is, generates the calibration data for adjusting the density gradation characteristics in the image forming section 18 for each color of CMYK. The density gradation characteristics refer to characteristics representing the output densities with respect to the input values of the image data. Moreover, when the user desires that the output densities be matched with those of the past density data, the control section 11 corrects the calibration data so that the output densities can be matched with those of the past density data selected from the operation section 12 by the user, and sets density gradation characteristics reproducing the past calibration selected by the user.

Here, a description will be made of a specific calibration method.

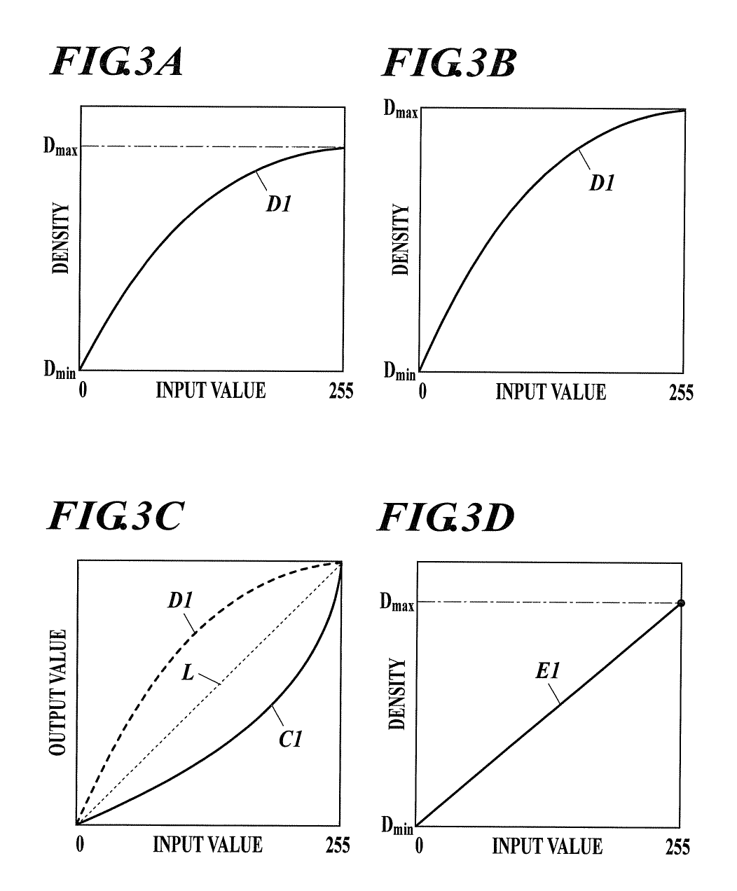

FIG. 3A shows an example of density data D1 with respect to each input value. The density data D1 is obtained by measuring the density of each patch of the calibration sheet 30 by the density measurement section 20. Dmin and Dmax, which are shown in FIG. 3A, are a minimum density and a maximum density, which are capable of being outputted in the image forming section 18 of the image forming apparatus 10 at present, respectively. As shown in FIG. 3B, an axis of ordinates in the graph of the density data D1 in FIG. 3A is revised so that a length from the minimum density Dmin to the maximum density Dmax can be equal to a length from 0 to 255 of the input value. Then, as shown in FIG. 3C, a graph that becomes axisymmetric to the density data D1 with respect to a line L of 45 degrees, which is drawn by dividing an angle between an axis of abscissas and an axis of ordinates in halves, is obtained. In such a way, calibration data C1 is generated. FIG. 3D shows density gradation characteristics E1 when gradation conversion processing is implemented for the image data by using the calibration data C1.

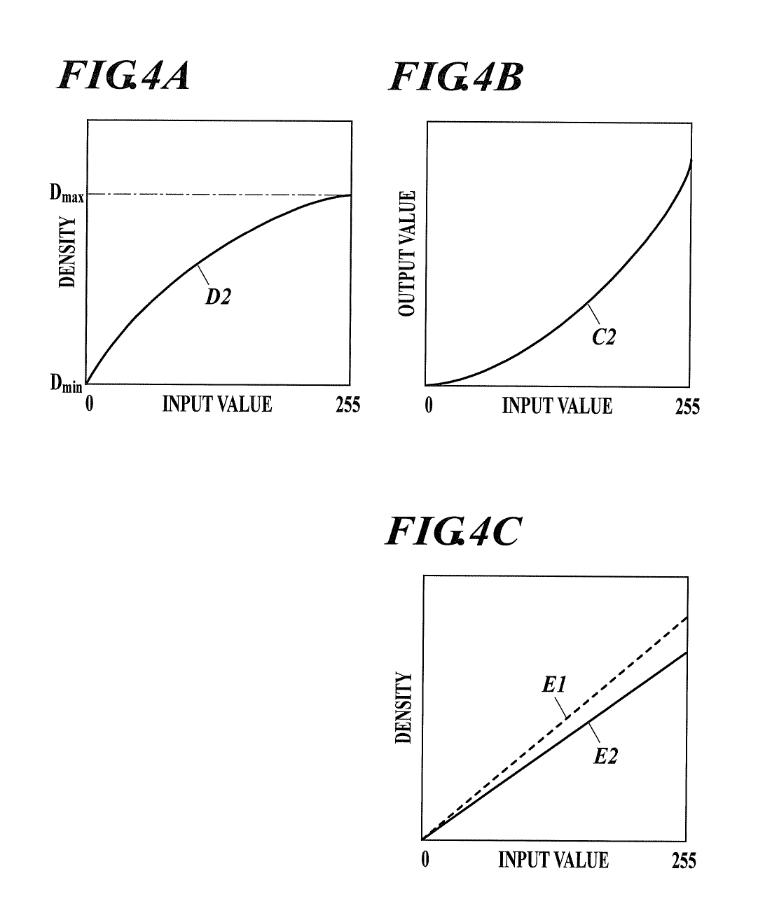

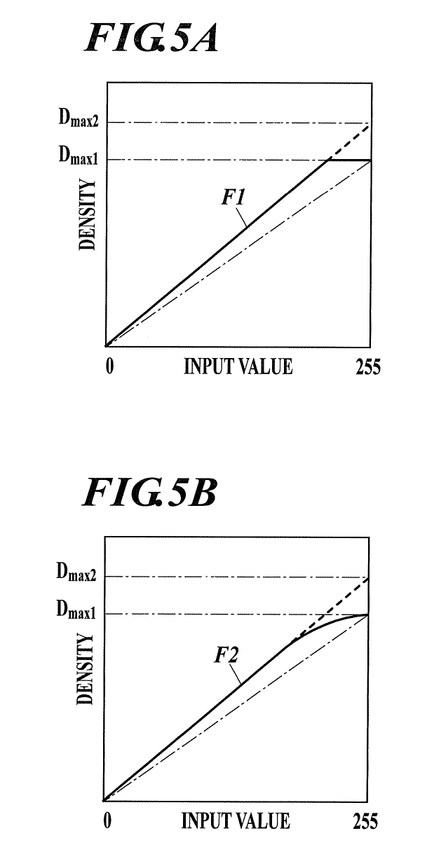

Moreover, when the user selects density data D2 in the past, which is shown in FIG. 4A, from among the past density data stored in the density data storage section 16, the calibration data C1 shown in FIG. 3C is corrected so as to be matched with the density data D2. FIG. 4B shows calibration data C2 obtained by correcting the calibration data C1. FIG. 4C shows density gradation characteristics E2 when the gradation conversion processing is implemented for the image data by using the calibration data C2. In accordance with the density gradation characteristics E2, a lower density output than that of the density gradation characteristics E1 which are not still matched with the past density data D2 can be realized.

Note that, when the calibration data is corrected so as to be matched with the past density data, in the case where the maximum density capable of being currently outputted is lower than a maximum density in the past density data, which the user desires to reproduce, a similar density to that in the past cannot be outputted with a density approximate to the maximum density. In this connection, as shown in FIG. 5A, when the maximum density capable of being currently outputted is defined as Dmax1, and the maximum density in the past density data is defined as Dmax2, such calibration data as establishing density gradation characteristics F1 in which the past densities equal to or more than the maximum density Dmax1 capable of being currently outputted are set at Dmax1 may be generated. Alternatively, as shown in FIG. 5B, such calibration data as establishing density gradation characteristics F2 which shifts smoothly to Dmax1 in a density around the maximum density Dmax1 capable of being currently outputted may be generated.

Moreover, the control section 11 performs such image processing as analyzing a page description language of the image data instructed to be printed from the external PC or the like and expanding the page description language to data of a bitmap format. Moreover, the control section 11 implements the gradation conversion processing for the image data based on the generated calibration data (the already corrected calibration data when the density of the image to be printed is matched with that of the past density data), and outputs, to the image forming section 18.

Next, an operations of the image forming apparatus 10 will be described.

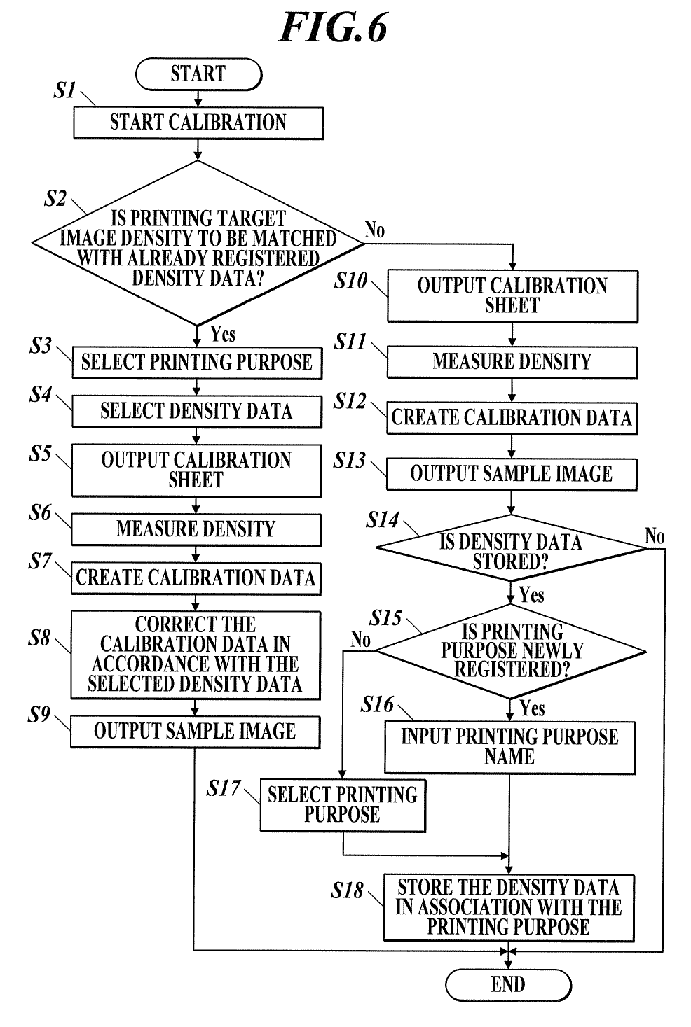

FIG. 6 is a flowchart showing the calibration processing executed in the image forming apparatus 10.

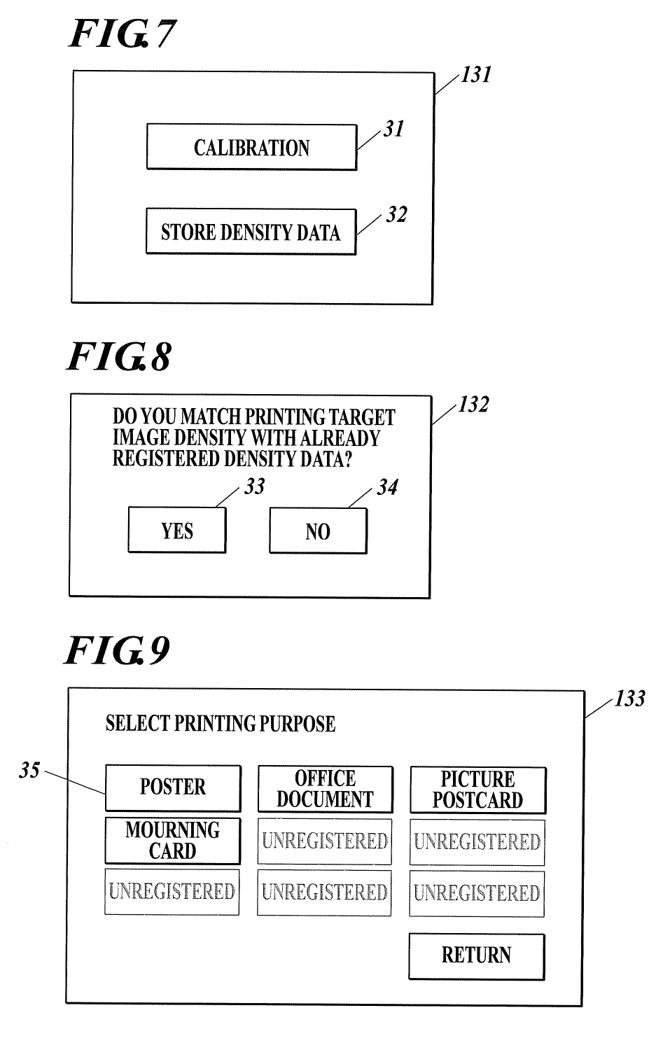

First, a function selection screen 131 shown in FIG. 7 is displayed on the display section 13 by the control section 11. Then, when the user selects a “CALIBRATION” button 31 from the touch panel of the operation section 12, the calibration is started (Step S1).

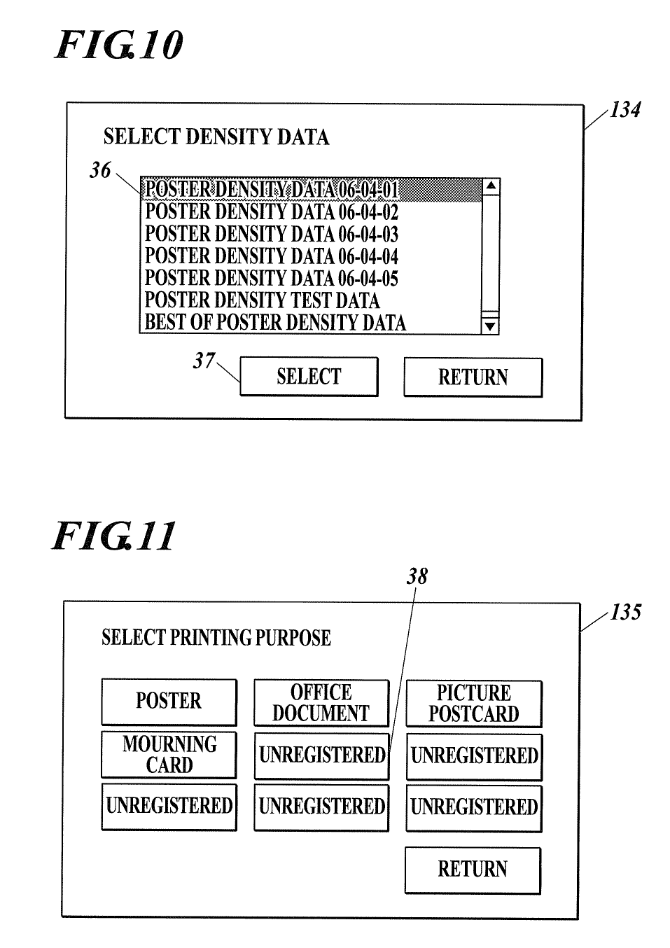

Next, a screen 132 to select whether or not to use already registered density data, which is shown in FIG. 8, is displayed on the display section 13 by the control section 11. Then, the user selects whether such printing target image density is to be matched with the already registered density data (the past density data) stored in the density data storage section 16 or is to be matched with the density data obtained by forming the calibration images newly by the image forming section 18 and measuring the calibration images by the density measurement section 20 (Step S2). When the user selects, from the touch panel of the operation section 12, a “YES” button 33 on the screen 132 to select whether or not to use the already registered density data, that is, when printing target image density is to be matched with the already registered density data stored in the density data storage section 16 (Step S2: Yes), a printing purpose selection screen 133 shown in FIG. 9 is displayed on the display section 13 by the control section 11.

When the user operates the touch panel of the operation section 12 on the printing purpose selection screen 133, thereby selecting any printing purpose from among the already registered printing purposes (Step S3), a file name of the density data stored in the folder corresponding to the selected printing purpose in the density data storage section 16 is read out by the control section 11, and a density data selection screen 134 (see FIG. 10) is displayed on the display section 13 thereby. For example, when the user selects, as the printing purpose, a “POSTER” button 35 shown in FIG. 9, a list of the past density data registered for the poster is displayed on the display section 13 as shown in FIG. 10.

Next, in the list of the density data on the density data selection screen 134, the user selects any one of the density data registered as the printing purpose selected in Step S3 by operating the touch panel of the operation section 12 (Step 54). For example, as shown in FIG. 10, the user selects “POSTER DENSITY DATA Jun. 4, 2001” 36, and fixes the selection by a “SELECT” button 37.

Next, the image processing is implemented for the image data of the calibration images, which is stored in the storage section 15, by the control section 11, and the image data is outputted to the image forming section 18. Then, the calibration images are formed on the printing sheet by the image forming section 18 based on the image data already subjected to the image processing, and the calibration sheet 30 is outputted (Step S5).

Next, the densities of the patches of the respective colors of CMYK on the calibration sheet 30 are measured by the density measurement section 20, and the density data (see FIG. 3A) for each color of CMYK is generated (Step S6). The generated density data is temporarily stored in the storage section 15.

Next, based on the density data newly measured by the density measurement section 20 and stored in the storage section 15, the calibration data (see FIG. 3C) for adjusting the density gradation characteristics in the image forming section 18 is generated for each color of CMYK by the control section 11 (Step S7).

Next, by the control section 11, the density data selected in Step S4 is read out from the density data storage section 16, and the calibration data generated in Step S7 is corrected in accordance with the selected density data (see FIG. 4B) (Step S8). The corrected calibration data is stored in the storage section 15. In such a way, the density gradation characteristics reproducing the past calibration, which are selected by the user, are set.

Next, by the control section 11, the image processing such as the gradation conversion processing is implemented for image data of a sample image based on the already corrected calibration data, and the image data is outputted to the image forming section 18 thereby. Then, based on the image data already subjected to the image processing, the sample image is formed on the printing sheet by the image forming section 18, and the sample image is outputted by the image output section 19 (Step S9). The sample image may be an image of the poster or the like that is actually printed, or may be a test image such as the calibration sheet 30.

Meanwhile, in Step S2, when the user selects, from the touch panel of the operation section 12, a “NO” button 34 on the screen 132 to select whether or not to use the already registered density data, that is, when the user does not use the already registered density data (Step S2: No), the image processing is implemented for the image data of the calibration images, which are stored in the storage section 15, by the control section 11, and the image data is outputted to the image forming section 18 thereby. Then, the calibration images are formed on the printing sheet by the image forming section 18 based on the image data already subjected to the image processing, and the calibration sheet 30 is outputted (Step S10).

Next, the densities of the patches of the respective colors of CMYK on the calibration sheet 30 are measured by the density measurement section 20, and the density data (see FIG. 3A) for each color of CMYK is generated (Step S11). The generated density data is temporarily stored in the storage section 15.

Next, based on the density data newly obtained by the density measurement section 20 and stored in the storage section 15, the calibration data (see FIG. 3C) is generated for each color of CMYK by the control section 11 (Step S12). The generated calibration data is stored in the storage section 15.

Next, by the control section 11, the image processing such as the gradation conversion processing is implemented for the image data of the sample image based on the calibration data generated in Step S12, and the image data is outputted to the image forming section 18 thereby. Then, based on the image data already subjected to the image processing, the sample image is formed on the printing sheet by the image forming section 18, and the sample image is outputted by the image output section 19 (Step S13).

Next, the function selection screen 131 shown in FIG. 7 is displayed on the display section 13 by the control section 11, and the user selects whether or not to store the density data newly measured and obtained by the density measurement section 20 in the density data storage section 16 (Step S14). When the user selects a “STORE DENSITY DATA” button 32 from the touch panel of the operation section 12 on the function selection screen 131, that is, when the new density data is stored in the density data storage section 16 (Step S14: Yes), a printing purpose selection screen 135 shown in FIG. 11 is displayed on the display section 13 by the control section 11.

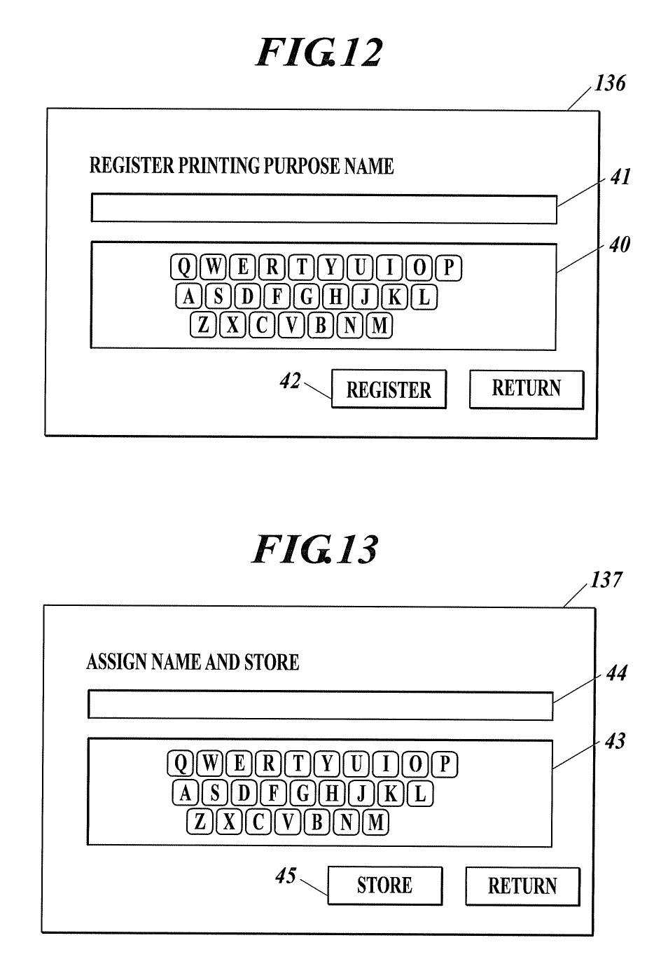

When the user selects an “UNREGISTERED” button 38 from the touch panel of the operation section 12 on the printing purpose selection screen 135, that is, the printing purpose of the density data is newly registered (Step S15: Yes), a printing purpose name registration screen 136 shown in FIG. 12 is displayed on the display section 13 by the control section 11. The user operates the touch panel of the operation section 12 on the printing purpose name registration screen 136, thereby inputting a printing purpose name (Step S16). Specifically, a character string inputted from a software keyboard 40 on the printing purpose name registration screen 136 is displayed on a printing purpose display column 41, and a “REGISTER” button 42 is selected, whereby the inputted printing purpose name is registered. In the density data storage section 16, a folder corresponding to the newly registered printing purpose is created.

In Step S15, when the printing purpose of the density data is not newly registered (Step S15: No), the printing purpose of the density data is selected from among the already registered printing purposes (Step S17). For example, when the user selects a “PICTURE POSTCARD” button 39 from the touch panel of the operation section 12 on the printing purpose selection screen 135 shown in FIG. 11, the new density data is registered as density data for the picture postcard in the density data storage section 16.

After Step S16 or Step S17, the user performs an operation from the touch panel of the operation section 12, whereby an arbitrary name is assigned to the density data obtained by the density measurement of this time, and the density data is stored in the density data storage section 16 in association with the printing purpose (Step S18). Specifically, a character string inputted from a software keyboard 43 on a density data storage screen 137 shown in FIG. 13 is displayed on a file name display column 44, and a “STORE” button 45 is selected, whereby the density data is stored in the folder for each of the printing purposes in the density data storage section 16 while being assigned with the inputted file name.

After Step S9, after Step S18, and when the new density data is not stored in the density data storage section 16 in Step S14 (Step S14: No), the calibration processing is ended.

Thereafter, based on the calibration data corrected in Step S8 or on the calibration data generated in Step S12, the image processing such as the gradation conversion processing is implemented for the data of the printing target image by the control section 11, and the image data is outputted to the image forming section 18 thereby. Then, by the image forming section 18, the printing target image is formed on the printing sheet based on the image data already subjected to the image processing.

As described above, according to the image forming apparatus 10, when the selection by the user from among the already registered density data stored in the density data storage section 16 is received from the operation section 12, and the user selects the density data desired to be reproduced, the density gradation characteristics reproducing the past calibration selected by the user is set. Consequently, the printing result similar to the printing result in the past can be obtained. Moreover, the density data storage section 16 is allowed to store the density data for each of the printing purposes, thus making it possible to use the density data suitable for the printing purpose.

Note that the description in the foregoing embodiment merely represents an example of the image forming apparatus according to the present invention, and the present invention is not limited to the embodiment. It is also possible to appropriately modify detailed configurations and operations of the respective sections composing the apparatus within the scope without departing from the spirit of the invention.

For example, though the density data is stored in the density data storage section 16 in the image forming apparatus 10 in the foregoing embodiment, the density data may be stored in an external device such as a printer controller connected to the image forming apparatus 10. Moreover, the gradation conversion processing for the image data, which is based on the instruction to perform the calibration and on the calibration data, may be performed by the external device such as the printer controller and the PC.

Moreover, in the foregoing embodiment, the description has been made of the case where the density data of the respective colors of CMYK, which is obtained by the density measurement, is stored in the density data storage section 16; however, the values convertible into the densities of the images, which include the brightnesses and the reflectances, may be stored. Moreover, data represented by a color space such as RBG, L*a*b*, and XYZ may be stored in place of storing the density data of the respective colors of CMYK.

Furthermore, in the foregoing embodiment, in order to obtain the printing result similar to the printing result in the past, the density data in the past is stored as the data related to the adjustment of the density gradation characteristics in the past calibrations; however, calibration data generated based on the density data in the past may be stored in advance.

Moreover, in the foregoing embodiment, the description has been made of the case where the density measurement section 20 includes the spectrophotometer of the incorporated type; however, a commercially available spectrophotometer may be used. Moreover, when the image forming apparatus 10 includes a scanner, the density data may be obtained by reading the calibration images by using the scanner.

Furthermore, when the density data is stored in the density data storage section 16, it is desirable that the sample image printed at that time be stored so as to make it possible to determine based on which density data the sample image is outputted. In such a way, it becomes easy to associate the density data for use with the printing result obtainable therefrom.

Moreover, in the foregoing embodiment, the instruction to execute the calibration and the instruction to select the past density data, which are related to the calibration, are received from the user through the operation section 12 provided in the image forming apparatus 10; however, in place of this, the instruction and the setting, which are related to the calibration, may be received from the external computer device connected to the image forming apparatus 10 through the communication section 14. In this case, the printing result similar to the printing result in the past can be obtained in accordance with the selection by the user, which is received through the communication section 14.

What is claimed is:

1. An image forming apparatus that adjusts density gradation characteristics based on density data obtained by forming a calibration image and measuring the formed calibration image to perform calibration, the image forming apparatus comprising:
a storage section to store data related to adjustments of the density gradation characteristics in past calibrations; and
a control section to set the density gradation characteristics which reproduces one of the past calibrations selected by a user, based on the data selected by the user from among the data stored in the storage section related to the adjustments of the density gradation characteristics in the past calibrations, and based on density data obtained by newly forming and measuring the calibration image.

2. The image forming apparatus of claim 1, wherein the storage section stores the data related to at least one adjustment of the density gradation characteristics in the past calibration with respect to each of printing purposes.

3. The image forming apparatus of claim 1, further comprising: an operation section to receive the selection by the user,
wherein the control section receives the selection by the user from the operation section.

4. The image forming apparatus of claim 1, further comprising:
a communication section to communicate with an external device,
wherein the control section receives the selection by the user from the external device through the communication section.

5. A calibration method of adjusting density gradation characteristics based on density data obtained by forming a calibration image and measuring the formed calibration image, the calibration method comprising the steps of:
storing data related to adjustments of the density gradation characteristics in past calibrations in advance in a storage section; and
setting the density gradation characteristics which reproduces one of the past calibrations selected by a user, based on the data selected by the user from among the data stored in the storage section related to the adjustments of the density gradation characteristics in the past calibrations, and based on density data obtained by newly forming and measuring the calibration image.

6. The calibration method of claim 5, wherein the storage section stores the data related to at least one adjustment of the density gradation characteristics in the past calibration with respect to each of printing purposes.

7. The calibration method of claim 5, wherein the selection by the user is received from an operation section.

8. The calibration method of claim 5, wherein the selection by the user is received from an external device through a communication section.
